(19) United States
(12) Patent Application Publication
(10) Pub. No.: US 2013/0229284 A1
(43) Pub. Date: Sep. 5, 2013

(54) GAS SAFETY MONITOR

(71) Applicants: Paul Basham, Abingdon (GB); Mark Osborne, Abingdon (GB)

(72) Inventors: Paul Basham, Abingdon (GB); Mark Osborne, Abingdon (GB)

(73) Assignee: CROWCON DETECTION INSTRUMENTS LIMITED, Abingdon, Oxfordshire (GB)

(21) Appl. No.: 13/821,105

(22) PCT Filed: Sep. 6, 2011
(86) PCT No.: PCT/GB2011/051667

§ 371 Date: May 21, 2013

(30) Foreign Application Priority Data
Sep. 7, 2010 (GB) 1014828.6
Jun. 15, 2011 (GB) 1110109.4

(51) Int. Cl. G01N 21/64; G08B 21/18

(52) U.S. Cl. CPC G01N 21/64; G08B 21/182
USPC 340/626; 250/458.1; 250/459.1; 250/216

(57) ABSTRACT

A dangerous level of gas safety monitor for indicating a level of a target gas in an atmosphere comprising: a sol-gel layer comprising a first phosphorescent material, exposed to the atmosphere; a light source enabled to stimulate the phosphorescent material; a detector enabled to detect light emitted by the phosphorescent material; a pressure sensor to determine the pressure of the atmosphere; a processor enabled to determine relative phase shift or time delay between the detected light emitted by the phosphorescent material and the emitted light of the light source, wherein the monitor is configured to provide an output indicative of a dangerous level of the target gas in the atmosphere, the output based on the determined pressure and relative phase shift or time delay.

### TECHNICAL FIELD

The present invention relates to low power long-life gas detectors with application including use in but not limited to industrial environments.

### BACKGROUND

It is known in industrial environments especially in gas plants and hazardous areas such as mines, gas wells and processing plants to detect the level of gas in an environment. The detection of gases is vital in ensuring the safety of any persons and property present in such an environment. In particular, it is desirable to be able to accurately measure the levels of gases such as O₂ CO₂ and H₂S as the presence (or absence) of these gases can be fatal or promote combustion leading to damage.

There are several known oxygen gas sensors that are commercially available. Lower cost sensors typically are lead based sensors which use a wet chemistry to detect the presence of gases. These sensors have a limited life span of a few years. Therefore, these sensors need to be replaced often due to their limited lifespan. Furthermore, they also are unable to function in warmer environments, typically above 50° C.

Infrared and laser based oxygen sensors are also commercially available. These tend to require a strong power source, such as a generator or the grid, to power the lamp, which means they are have a limited range. Alternatively they can be battery based.

An object of the invention is produce a long lasting, gas detector that provides rapid results and is able to function in many environments including industrial environments.

To mitigate at least some of the above problems there is provided a dangerous level of gas safety monitor for indicating a level of a target gas in an atmosphere comprising: a sol-gel layer comprising a first phosphorescent material, exposed to the atmosphere; a light source enabled to stimulate the phosphorescent material; a detector enabled to detect light emitted by the phosphorescent material; electronics enabled to determine relative phase shift or time delay between the detected light emitted by the phosphorescent material and the emitted light of the light source, wherein the monitor is configured to provide an output indicative of a dangerous level of the target gas in the atmosphere, the output based on the determined relative phase shift or time delay.

Preferably further comprising a pressure sensor to determine the pressure of the atmosphere and wherein the output is based on the determined pressure as well as the determined relative phase shift/time delay.

Preferably further comprising a protective layer placed on top of the sol-gel layer, such as a gas porous non-phosphorescent plastic.

Preferably wherein the monitor is enabled to detect the presence of one or more additional target gases and the monitor further comprises: one or more layers of sol-gel comprising a plurality of different phosphorescent materials, and optionally a plurality of light sources emitting at different wavelengths to stimulate the plurality of phosphorescent materials, and optionally a plurality of filtering materials in order to detect light of different wavelengths.

Preferably wherein the phosphorescent material used is based on the materials collisional quenching responses to different target gases, and wherein the phosphorescent material is Ruthenium oxide and the target gas is oxygen.

Preferably, wherein the light source is a low power light source, such as an LED, preferably less than 1 mW.

Preferably wherein the monitor has a protective outer housing which housing contains the light source and the detector and the monitor comprise a power source located inside the housing and connect to power one or more of the processor, light source, detector and pressure sensor.

Preferably wherein the monitor further comprises a display enabled to display the level of target gas in the atmosphere, the output being provided at least partially by use of the display and/or wherein there is an alarm enabled to sound or light when the level of target gas is outside or inside of a predetermined range, the output being provided at least partially by use of the alarm.

Preferably wherein the pressure is measured for example by an electronics package e.g. NPP-301B-200A from GE sensing.

### BRIEF DESCRIPTION OF THE DRAWINGS

Embodiments of the invention are now described, by way of example only, with reference to the accompanying drawing in which:

FIG. 1 shows a schematic representation of a personal safety monitor according to an aspect of the invention;

FIG. 2 is a flow chart of the process of determining the level of gas in an atmosphere; and

FIGS. 3a and 3b are plots used to calculate the correction required to compensate for the measured pressure.

### DETAILED DESCRIPTION OF AN EMBODIMENT

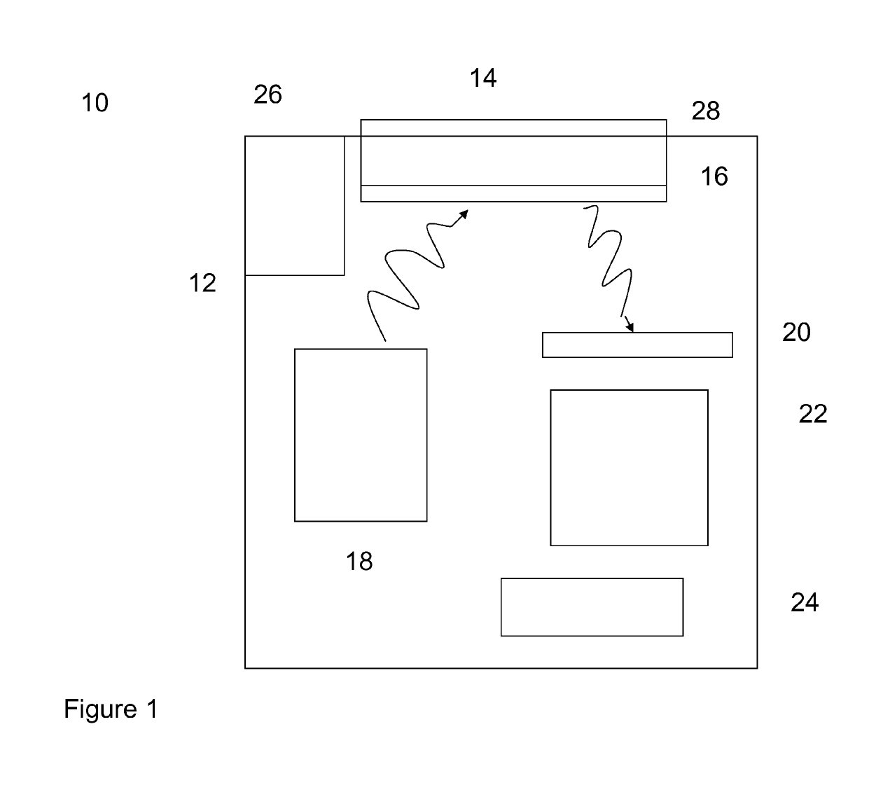

FIG. 1 is a schematic representation of a personal gas safety monitor 10. The monitor 10, comprises: an outer housing 12; a gas testing element 14; a substrate 16; a light source 18 such as a blue LED; a filter 20 such as a red filter; detector 22; processor 24; a pressure sensor 26; and a protective layer 28.

In one preferred embodiment the personal safety monitor 10 is designed to be portable and carried on the person to indicate the detection, or absence, of one or more target gases. The monitor 10 therefore allows for the detection of dangerous levels of a gas. This may be an unacceptably high level of a gas e.g. H₂S, or an unacceptably low level of a gas e.g. O₂. It is desirable to be able to quickly detect changes in the levels of gas, as any significant delay may adversely affect the health of the user. Furthermore, it is desirable to have a cheap, long lasting, sensor that can be repeatedly used over an extended period of time without noticeable degradation in the accuracy or speed of the sensor.

There is provided a portable safety monitor 10 which is contained within a rugged housing 12. The housing 12 is preferably air tight and houses the light source 18; filter 20; detector 22; and processor 24. It also houses a power source and may house a display and/or alarm (not shown).

On the exterior of the monitor 10 (i.e. on the housing 12) there is a pressure sensor 26, alternatively the pressure sensor 26 may be kept within the housing. The pressure sensor 26 can be a known commercially available sensor enabled to accurately measure the atmospheric pressure to within a few millibar. On the exterior of the housing 12 or within the housing, positioned so that it is contact with the atmosphere in which the monitor 10 is held is the gas testing element 14. The gas testing element 14 includes a phosphorescent material and is preferably a sol-gel which is doped with the phosphorescent material. The composition of the gas testing element 14 is discussed in detail below. The gas testing element/sol-gel layer is placed on a substrate 16. The substrate 16 is typically quartz which is transparent to the frequency of the light source 18, and is placed on the external layer of the housing 12 or incorporated as part of the housing 12. Optionally, the gas testing element 14 is covered by a protective layer 28.

The outer housing 12 is preferably made from a rugged thermoplastic. Personal safety monitors 10 are used in industrial environments such as mines, and might typically be exposed to harsh environments. Accordingly, the monitor 10 is designed to withstand impacts and shocks which typically occur in such environments.

Inside the monitor 10 there is a light source 18, preferably a blue LED, which is positioned so that it emits light onto the gas testing element 14, potentially through the substrate 16. As the gas testing element 14 includes a phosphorescent material, the phosphorescent material will be excited by the photons of the light source 18 and subsequently reemit part of the energy as the phosphorescent material returns to a lower energy state. The timescale of the phosphorescence emission is known to depend on the phosphorescent material and with some materials the timescale of emission is known to vary according to the presence of certain gases in a process called collisional quenching.

The light emitted from the phosphorescent material is at a different wavelength to the stimulating light from the light source 18, the wavelength of emission being dependent on quantum energy states of the phosphorescent material. A detector 22, such as a silicon detector, is used to detect the phosphorescence emission.

To aid with the detection of the light from the gas testing element 14 a filter 20 which corresponds to the wavelength of light emitted from the gas testing element 14 is placed between the detector and element 14. The filter 20 therefore removes the majority of light that is not emitted from the element 14 and improves the signal to noise ratio received by the detector 22 by substantially removing the emission from other sources, in particular the light source 18 and a proportion of the ambient light from external light sources located outside the product.

The detector 22 and light source 18 are connected to a processor 24. The processor 24 is enabled to detect the phase difference between the light emitted by the light source 18 and received by the detector 22, the phase difference being a measure of the time delay between emission and detection. As the delay is dependent on the rate of collisional quenching caused by the presence of gas, changes in the phase difference as determined by the processor 24 can be used to determine a change in the composition of the gas that the phosphorescent material is exposed to.

It is beneficially found that a pressure sensor 26 provides an increased accuracy in the results when determining the presence of gases in an atmosphere. As discussed above, the rate of decay of the phosphorescent material varies due to collisional quenching.

The rate of collisional quenching is proportional to the amount of gas present in the atmosphere to which the phosphorescent material is exposed. However, it has been found by the applicant that it is difficult to determine if a change in decay rate is due to an increase in the amount of gas present or an increase in pressure. In personal safety applications such as gas refineries, mines or underground it is important to know if the change in the presence of a particular gas is due to a change in pressure or an actual increase or decrease in a particular gas. For example, an increase in a particular type of gas, such as H₂S (hydrogen sulphide), may indicate a leak or the presence of a bubble of such a gas which could potentially be fatal. However, an increase in the number of H₂S molecules may be acceptable if it is as a result of an increase in pressure.

The pressure sensor 26 is placed on the housing 12. The pressure sensor 26 can be a commercially available barometric pressure sensor which are found in mining. The pressure sensor 26 is able to accurately measure the pressure in the range of atmospheric pressures typically found in mines, refineries etc.

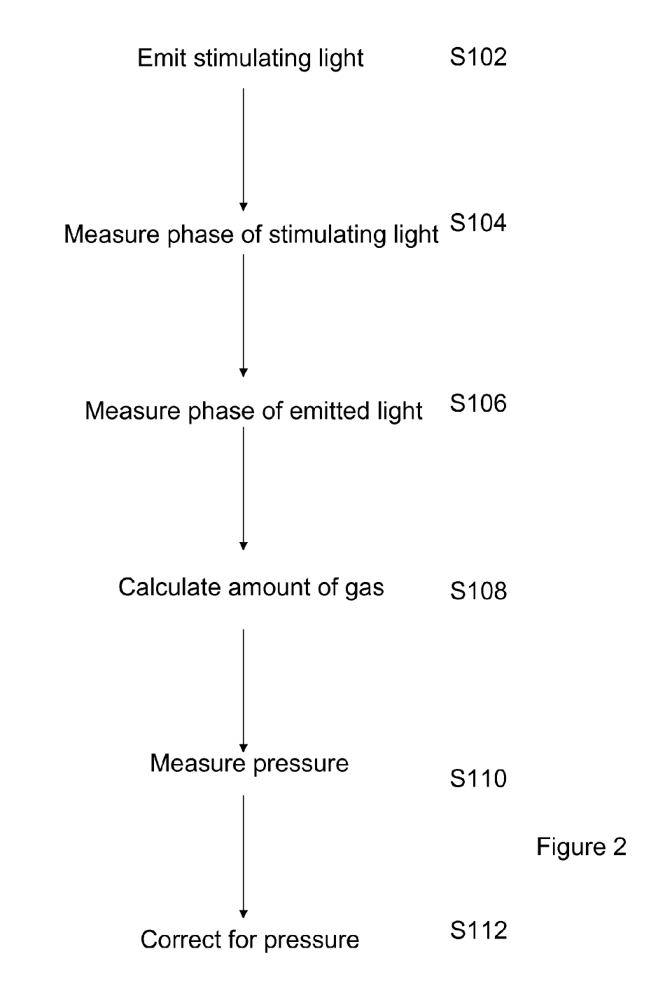

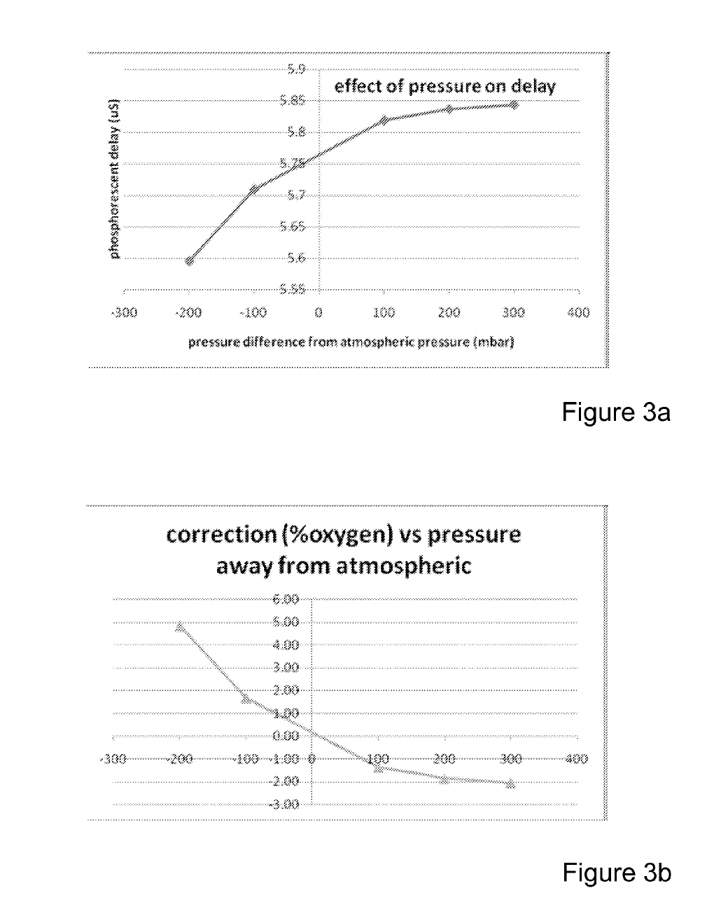

Using the measurement of the pressure sensor 26 it is possible for the processor 24 to take into consideration any variations in pressure and obtain an absolute measure of the presence of gas in an atmosphere. This process is described in further detail with respect to FIGS. 2 and 3.

In a second preferred embodiment it is known that a similar gas detector may be fixed in location in order to provide protection for personnel and equipment in that location. In a preferred embodiment, the phosphorescent material is Ruthenium oxide (RO₂) which is doped into a sol-gel matrix. Sol-gel is a commercially available material which when dried produces a porous ceramic material. It is known for sol-gel to be doped so as to contain a uniform distribution of the doping material.

By doping the sol-gel with a phosphorescent material it allows for the easy application of phosphorescent material to a number of surfaces. In the detector the sol-gel doped with the phosphorescent material can be applied to a substrate 16 using known printing techniques thereby avoiding the need for expensive manufacture of shaped sensors.

Ruthenium oxide is known to have an unquenched decay time of approximately 5 μs (microseconds). Ruthenium oxide is known to be collisional quenched in the presence of O₂ with the increase in decay time being related to the amount of O₂ present in the atmosphere to which it is exposed. Ruthenium oxide is excited at ˜470 nm and emits at ˜600 nm to 630 nm

It has beneficially been realised that the quantum mechanical properties of the

Ruthenium oxide to produce a low-power long life system. The Ruthenium oxide will undergo phosphorescence emission when stimulated with a light of the correct frequency even if the light is of a very low power. Therefore the light source 18 can be a low powered blue LED, typically 1 mW or less. An advantage of the present system is that as the system is low powered, LEDs that have a typical lifetime in excess of 25,000 hours can be used and the low power of the lights means that conventional power sources such as batteries can have a lifespan of several years. The sol-gel doped with Ruthenium oxide will similarly be long lived as the sol-gel provides a stable matrix and the light which stimulates the phosphorescent material is of low intensity and therefore does not cause the phosphorescent material to degrade as rapidly as if it were stimulated by a higher intensity light. Therefore, personal safety monitor 10 typically has a usable lifetime of a number of years.

Furthermore, to increase the accuracy of the measurements by the detector a filter 20 is placed in front of the detector 22. As the light emitted from the sol-gel layer 16 is at ˜600 nm to 630 nm a red filter 20 will filter the light leaving a strong signal from the emission from the sol-gel layer.

The detector 22 can be a known commercially available Silicon detector.

In further embodiments the sol-gel layer 16 comprises several layers with different dopes in each layer. The different dopes are different phosphorescent materials each chosen for their different collisional quenching properties for different gases. Depending on the phosphorescent material chosen, and their wavelengths of stimulation then there may be one of more different light sources 18 which emit at different frequencies so as to stimulate the phosphorescent material or similar frequencies but different stimulation timescales. This arrangement of multiple phosphorescent materials within the sol-gel layer 16 allows for the detection of several gases within the same monitor 10.

In a further embodiment, to increase the accuracy of the measurement and to reduce the number of spurious signals which may occur from stimulation of the sol-gel layer 16 and Ruthenium oxide from external light sources, a protective layer 28 is placed over the sol-gel layer 16. The protective layer 28 is a non-phosphorescent material which is gas permeable, such as a black gas-permeable plastic. The protective layer 28 is preferably opaque to the light wavelengths that stimulate the phosphorescent material which are doped in the sol-gel layer. This prevents the sol-gel layer 16 being stimulated by external light sources which could affect the detection of gas, as well as providing a physical protection to the sol-gel layer 16. As the protective layer 28 is gas permeable the detection of the target gases in the atmosphere is not adversely affected. Furthermore, as the gas monitors 10 are expected to be used in industrial areas, such as mines the personal safety monitor 10 will typically be subjected to impacts and shocks. Therefore, the protective layer 28 provides protection to the sol-gel layer 16 against such impacts.

The electronics or processor 24 is enabled to determine the presence (or amount) of the target gas in the atmosphere. A method of determining the presence of gas is discussed in detail with reference to FIG. 2.

The monitor 10 may also comprise a display and/or alarm (not shown). The display is preferably a known backlit LED display enabled to display the value of the gas detected and the type of gas. The alarm is preferably a visual and audible alarm, and is enabled to turn on when the levels of gas detected are outside of predefined safe limits. The visual alarm may be a series of lights, which are lit according to the level of gas detected. For example, a safe level of oxygen would be indicated by a green light and an unsafe level by a red light.

Therefore, the monitor has an output which is understood by the user as an indicator of the level of the target gas detected. The output therefore allows the user to know if the atmosphere is safe.

The monitor 10 also comprises a power source such a battery (not shown). As the light source 18 is a low powered source, the power source typically lasts a number of years.

The processor 24, light source 18, and detector 22 are placed on a single printed circuit board allowing for the cheap manufacture of the component parts.

An advantage of the apparatus described is that it may be manufactured at a relatively low cost with a high reliability. The sol-gel layer 16 and phosphorescent material have a long life time as does the light source 18 and detector 22. The low powered nature also means the power source will be long lasting. A further advantage is that such systems are also useable in a wider range of environments than, say, a wet chemistry gas detector which has a maximum temperature of approximately 50° C. Furthermore, the timescales for decay of the phosphorescent material are typical milliseconds and the time taken for a change in decay time due to a variation in the number of atoms present is also similarly fast. Therefore, the present apparatus can detect a change in the gas composition in timescales of less than a second.

FIG. 2 is a flow chart of the process for calculating the amount of O₂ present in the atmosphere to which the monitor 10 is placed.

There is shown the step of exciting the phosphorescent material at step S102; measuring the phase of the light source at step S104; measuring the phase of the light emitted by the phosphorescent material at step S106; calculating an initial value of the percentage of gas present at step S108; measuring the pressure of the atmosphere at step S110; and correcting for the pressure at step S112.

The monitor 10 measures the decay time of the phosphorescent material using by calculating the phase shift between the exciting light from the light source 18 and the emitted light from the phosphorescent material in the sol-gel layer 16. Methods of calculating decay times via phase shift such as described in “A new method for phosphorescence measurements in the presence of scattered light” (Campo et al Proceedings, XVII IMEKO World Congress) may be used. It is found that the measurement of phase shift is a more reliable than fitting the observed data with an exponential decay function. In particular as over time the phosphorescent material in the sol-gel layer 16 is expected to degrade and the fitting of the decay function becomes less accurate, however the phase shift should remain mostly unchanged.

At step S102 the light source 18 is pulsed at 40 KHz for a period of 1 second using an amplitude modulated signal. The phase of the of the stimulating light of the light source 18 is determined at step S104.

At step S106 the light emitted by the phosphorescent material in the sol-gel layer 16 is detected by the detector 22 and measured. As discussed previously, to improve the signal the light is preferably filtered using a colour filter which corresponds to the wavelength of emission of the phosphorescent material to reduce the unwanted signal from other sources of emission. The phase difference can be converted into a measure of decay time using the method of Campo et al. The presence of oxygen in the atmosphere of the RuO₂ is known to change the decay time at a rate proportional to the number of oxygen atoms present. This gives a measure of the amount of gas present in the atmosphere at step S108. In a further embodiment, the time delay between the emission of the light source 18 and sol-gel layer 16 is calculated as a measure of phosphorescence.

This measure at step S108 is a measure of the number of oxygen molecules present and it may be as result of an increase in pressure or an actual increase in the presence of O₂. At step S110 the pressure of the atmosphere is measured, using the pressure sensor 26.

At step S112 an adjustment is made for the pressure measured at step S110. For the Ruthenium Oxide the variation in decay time with pressure has been determined experimentally. It has been found that the variation in decay time with pressure can be modelled using a near linear function. From the measure of the pressure it is possible to return a corrected value which takes into account the variation in pressure at step S112. The number of collisions and hence the number of molecules of oxygen present gives the amount of oxygen present. The pressure measurement then gives the amount of total atmosphere present compared with a reference point taken during the calibration of the system. This yields the proportion of the atmosphere that is oxygen.

It is found that accurate measures of the amount of O₂ present in the atmosphere can made within 2 seconds of the excitation of the sol-gel layer. Thus providing a rapid and accurate system.

Whilst FIG. 2 has been described with specific reference to the detection of oxygen in an atmosphere using a Ruthenium Oxide phosphorescent material, the same principles may be extended towards the detection of other types of gases using different phosphorescent material. Similarly, the above method can be used for determining the presence of multiple types of gas in an atmosphere where the sol-gel layer 16 has two or more layers with different phosphorescent materials.

FIG. 3 is a plot of the correction curves used to correct the gas calculations for the measured pressure as per steps S110 and S112 of FIG. 2.

The decay time of the phosphorescent material is dependent on collisional quenching. The number of target gas particles in a volume may vary due to either a change in the concentration of the target gas(es), or a change in the pressure of the atmosphere sampled which would increase or decrease the amount of collisional quenching whilst the relative abundance of the target gas remains unchanged. In order to improve the accuracy of the sensor it is desirable to be able to differentiate between either situation. In particular, it is desirable to be able to differentiate between an increase in pressure (resulting increase in collisional quenching) and increase in the concentration of a target gas (also resulting in an increase in collisional quenching).

FIG. 3a is a plot of the correction curve for the difference in phosphorescent delay due to the change in atmospheric pressure at a fixed concentration of a target gas. In the plot shown in FIG. 3a the target gas is oxygen and the active layer is RuO₂. There is shown the variation in atmospheric pressure (in mbar) along the x-axis and the expected phosphorescent delay along the y-axis. From the graph it is apparent a reduction in pressure results in a reduction in phosphorescent delay. Therefore without correcting for the change of pressure a change in phosphorescent delay due to a change in pressure would be indistinguishable form a change in phosphorescent delay due to a change in concentration.

Accordingly, less accurate readings may result by not taking into account the variations due to pressure. In the plot shown the effect of 0.5 atmospheres pressure difference can result in a difference in the measured oxygen level versus the actual oxygen level of 7%.

In an embodiment, the delay time for a range of concentrations of a target gas across a range of pressures is stored on a memory in the form of a look up table or database. By measuring the pressure of the atmosphere being sampled, pressure corrected phosphorescent decay times can be looked up and a pressure corrected concentration of a target gas can be determined. Accordingly, by measuring the pressure a more accurate result is achieved by compensating for the change in phosphorescent delay times. The same principle may also be applied to determine the change in phase shift according to pressure.

In further embodiments different correction factors may also be applied. For example, as shown FIG. 3b, correction applied to the measured value of a target gas may be applied. In such an embodiment a non-pressure compensated value for a gas is determined (the non-pressure compensated value calculated assuming that the measurement was made at atmospheric pressure) and a correction factor is applied to the calculated value, the correction factor being dependent on the measured pressure.

FIG. 3b is a plot of the correction factor needed to compensate for oxygen at different pressures. There is shown the change in pressure from atmospheric pressure along the x-axis and the percentage correction along the y-axis. As can be seen sampling an atmosphere at below atmospheric pressure would result in an underestimate of the actual oxygen level.

In such an embodiment, if a target gas is measured in atmosphere of, say, 1050 mbar a percentage decrease from the determined level of gas of approximately 0.5% is applied to the measured level of gas to correct for the atmospheric pressure.

This information is preferably stored in the form of look up tables and/or databases associated with the sensor and by using the measured pressure a correction factor can be easily determined. The skilled person would be able to construct such correction curves either through the use of experimental data or by modelling the change in response times at different pressures.

Therefore, by compensating for pressure a more accurate measure of the concentration of a target gas can be made. Furthermore, the ability to correct for pressure allows for the distinction between a change in pressure and a change in concentration. This is particularly beneficial in hazardous environments. Such information can be stored in the form of a look up table or database connected to or associated with the sensor.

1. A gas safety monitor for indicating a level of a target gas in an atmosphere comprising:
a sol-gel layer comprising a first phosphorescent material, exposed to the atmosphere;
a light source enabled to stimulate the phosphorescent material;
a detector enabled to detect light emitted by the phosphorescent material;
a processor enabled to determine relative phase shift or time delay between the detected light emitted by the phosphorescent material and the emitted light of the light source;
a pressure sensor to determine the pressure of the atmosphere, and amount of gas present;
wherein the monitor is configured to provide an output indicative of a level of the target gas in the atmosphere, the output based on the determined pressure and relative phase shift or time delay and
wherein the pressure correction is based on a factor of the determined output as a proportion of the measured amount of gas present.

2. The monitor of claim 1 wherein the target gas is oxygen.

3. The monitor of claim 1 further comprising a protective layer placed on top of the sol-gel layer.

4. The monitor of claim 3 wherein the protective layer is a gas porous non-phosphorescent plastic.

5. The monitor of claim 1 wherein the monitor is enabled to detect the presence of one or more additional target gases and the monitor further comprises:
one or more layers of sol-gel comprising a plurality of different phosphorescent materials.

6. The monitor of claim 5 further comprising a plurality of light sources emitting at different wavelengths to stimulate the plurality of phosphorescent materials.

7. The monitor of claim 1 wherein the phosphorescent material used is based on the materials collisional quenching responses to different target gases.

8. The monitor of claim 1 wherein the first phosphorescent material is Ruthenium oxide and the target gas is oxygen,

9. The monitor of any preceding claim 1 wherein the proportion of the total atmosphere present of different target gases is determined by use of a pressure sensor as a ratio of the gas measured to the total gas present as determined by the pressure sensor.

10. The monitor of claim 1 wherein the light source is a low power light source, such as an LED, preferably less than 1 mW.

11. The monitor of claim 1 wherein the monitor has a protective outer housing which housing contains the light source and the detector.

12. The monitor of claim 11 wherein the monitor comprise a power source located inside the housing and connect to power one or more of the processor, light source, detector and pressure sensor.

13. The monitor of claim 1 wherein the monitor further comprises a display enabled to display the level of target gas in the atmosphere, the output being provided at least partially by use of the display.

14. The monitor of claim 1 further comprising an alarm enabled to sound or light when the level of target gas is outside or inside of a predetermined range, the output being provided at least partially by use of the alarm.

15. The monitor of claim 1 associated with one or more look up tables and/or databases comprising information on the variation in phase shift and/or time delay and/or concentration target gas delay due to a change in pressure.

16. The monitor of claim 15 wherein the output indicative of a dangerous level of the target gas in the atmosphere is varied according to the information held in tables and/or databases.

17. A method of determining the level of a target gas in an atmosphere, the method comprising the steps of:
stimulating a phosphorescent material contained in a sol-gel, said phosphorescent material having a decay time that varies according to the presence of the target gas;
measuring the phase of the stimulating emission;
measuring the phase of the emission of the phosphorescent material;
measuring the pressure of the atmosphere and amount of gas present;
providing an output indicative of a level of the target gas in the atmosphere, the output based on the determined pressure and relative phase shift or time delay and wherein the pressure correction is based on a factor of the determined output as a proportion of the measured amount of gas present.

18. The method of claim 17 wherein the target gas is oxygen.
